(19) United States
(12) Patent Application Publication
(10) Pub. No.: US 2019/0361662 A1
(43) Pub. Date: Nov. 28, 2019

(54) SELECTION OF A DISPLAY DEVICE FROM WHICH TO SEND DISPLAY CONTENT TO A REMOTE COMPUTING SYSTEM

(71) Applicant: HEWLETT-PACKARD DEVELOPMENT COMPANY, LP., Spring, TX (US)

(72) Inventors: Syed S. Azam, Spring, TX (US); Georgios Mandamadiotis, Spring, TX (US); Sarit Williams, Spring, TX (US); Stephen Hinton, Spring, TX (US); Rick Pham, Spring, TX (US)

(73) Assignee: HEWLETT-PACKARD DEVELOPMENT COMPANY, LP., Spring, TX (US)

(21) Appl. No.: 16/483,010

(22) PCT Filed: Feb. 1, 2017
(86) PCT No.: PCT/US2017/015965

§ 371 Date: Aug. 1, 2019

(51) Int. Cl. G06F 3/14; G09G 5/12; G06F 3/02

(52) U.S. Cl. CPC G06F 3/1454; G09G 2370/10; G06F 3/0227; G09G 5/12

(57) ABSTRACT

In an example, a host computing system includes a plurality of display devices. A method is described that includes initiating, in response to a first signal received from a user input device of the host computing system, a timer to count down a defined period of time. A first display device of the plurality of display devices is selected, based on whether a second signal has been received from the user input device before an expiration of the timer. A plurality of data packets is then sent to a remote computing system. The plurality of data packets contains content of a display of the first display device.

### BACKGROUND

Many computer applications, including virtual meeting and conference calling applications, include screen sharing capabilities. Screen sharing allows a host computing system to share content from its display device with one or more remote computing systems, e.g., by sending the shared content to the remote computing systems for display on their respective display devices.

### BRIEF DESCRIPTION OF THE DRAWINGS

FIG. 1 depicts a high-level block diagram of an example host computing system that can be transformed into a machine capable of performing the functions described herein;

FIG. 2 illustrates a flow diagram of a method for selecting a display device from which to send display content to a remote computing system;

FIG. 3 illustrates a flow diagram of another method 300 for selecting a display device from which to send display content to a remote computing system; and

FIGS. 4A-4C illustrate an example queue of display devices during different stages of the method illustrated in FIG. 3.

### DETAILED DESCRIPTION

The present disclosure describes an apparatus, method, and non-transitory computer-readable medium for selecting a display device from which to send display content to a remote computing system. As discussed above, computer applications, including virtual meeting and conference calling applications, include screen sharing capabilities. Screen sharing allows a host computing system to share content from its display device with one or more remote computing systems, e.g., by sending the shared content to the remote computing systems for display on their respective display devices. In some cases, the host computing system may include multiple display devices (e.g., a multiple monitor configuration), where any of the multiple display devices may be selected for sharing. Selecting the desired display device from among the multiple display devices may be a cumbersome process that involves multiple steps and input/output devices (e.g., mouse, keyboard) to complete.

Examples of the present disclosure provide hardware, or a combination of hardware and software, that allows the user of a host computing system including a queue of multiple display devices to easily select a display device for screen sharing. For instance, examples of the present disclosure allow the user to select the desired display device by pressing a dedicated button (e.g., a single dedicated button or a series of dedicated buttons) on the host computing system's wired or wireless keyboard. Pressing the button once will make a preliminary selection of a default display device. If the user presses the button again before a defined period of time expires, the next display device in the queue will be selected. This process continues through the queue until the defined period of time expires following the most recent button push. At this time, the host computing system will finalize selection of the currently selected display device and begin sending packets of data to a remote computing system, where the packets of data include content displayed on the currently selected display device.

Within the context of the present disclosure, a “dedicated” button may comprise a button having no other functionality but to enable the selection of a display device for screen sharing. The dedicated button may also comprise a button that has some other default functionality (e.g., a letter or number key, a function key, or the like) but can be selectively “locked” to enable the selection of a display device for screen sharing. In this case, the button will operate as a dedicated button capable of performing the methods described herein until it is “unlocked” and resumes its default functionality, Moreover, within the context of the present disclosure, a “button” may comprise a button of a hardware keyboard (e.g., a mechanical or capacitive button). The button may also comprise a touch-sensitive region of a “virtual” keyboard (e.g., displayed on a touch-screen device).

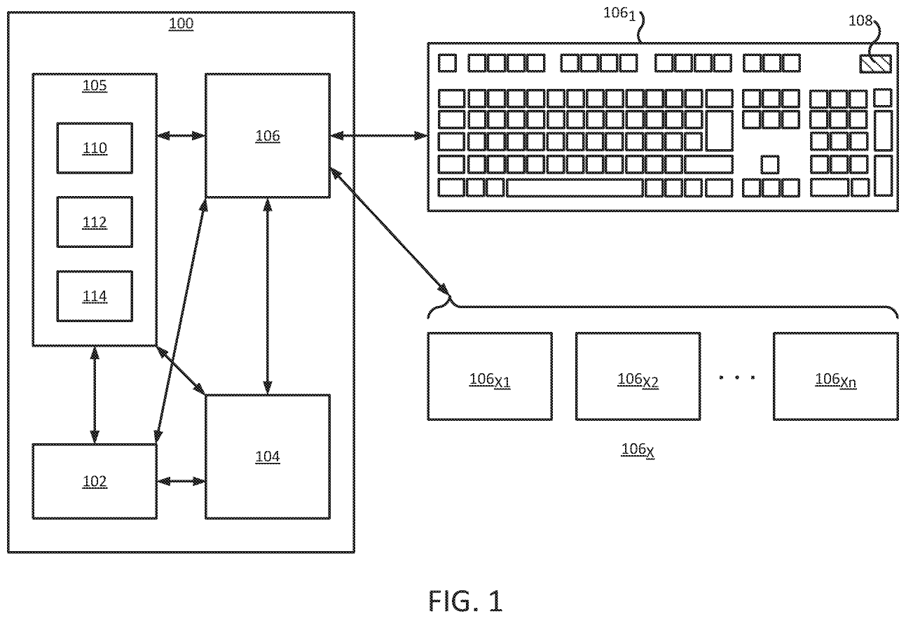

FIG. 1 depicts a high-level block diagram of an example host computing system 100 that can be transformed into a machine capable of performing the functions described herein. As a result, the examples of the present disclosure modify the operation and functioning of the general-purpose computer to allow the user of a host computing system including a queue of multiple display devices to easily select a display device for screen sharing, as disclosed herein.

As depicted in FIG. 1, the host computing system 100 comprises a hardware processor element 102, e.g., a central processing unit (CPU), a microprocessor, or a multi-core processor, a memory 104, e.g., a temporary memory such as random access memory (RAM) and/or read only memory (ROM), a screen sharing module 105 for selecting a display device from which to send display content to a remote computing system, and various input/output (I/O) devices 106, e.g., storage devices, including but not limited to, one or more of: a tape drive, a floppy drive, a hard disk drive or a compact disk drive, a receiver, a transmitter, a speaker, a display, a speech synthesizer, an output port, an input port and a user input device, such as a keyboard, a keypad, a mouse, a microphone, and the like. In the example illustrated in FIG. 1 the I/O devices 106 include at least a user input device 106₁ (e.g., a wired or wireless keyboard in the illustrated example) and a queue 106ₓ of display devices (e.g., monitors in the illustrated example) 106ₓ₁-106ₓₙ.

Although one processor element is shown, it should be noted that the host computing system 100 may employ a plurality of processor elements. Furthermore, although one host computing system 100 is shown in the figure, if the method(s) as discussed below is implemented in a distributed or parallel manner fora particular illustrative example, i.e., the blocks of the below method(s) or the entire method(s) are implemented across multiple or parallel host computing systems, then the host computing system 100 of this figure is intended to represent each of those multiple host computing systems. Furthermore, a hardware processor can be utilized in supporting a virtualized or shared computing environment. The virtualized computing environment may support a virtual machine representing computers, servers, or other computing devices. In such virtualized virtual machines, hardware components such as hardware processors and computer-readable storage devices may be virtualized or logically represented.

It should be noted that the present disclosure can be implemented by machine readable instructions and/or in a combination of machine readable instructions and hardware, e.g., using application specific integrated circuits (ASIC), a programmable logic array (PLA), including a field-programmable gate array (FPGA), or a state machine deployed on a hardware device, a host computing system or any other hardware equivalents, e.g., computer readable instructions pertaining to the method(s) discussed below can be used to configure a hardware processor to perform the blocks, functions and/or operations of the below disclosed methods.

In one example, instructions and data for the present module or process 105 for screen sharing, e.g., machine readable instructions can be loaded into memory 104 and executed by hardware processor element 102 to implement the blocks, functions or operations as discussed below in connection with the methods 200 and 300. For instance, the module 105 may include a plurality of programming code components, including a timer component 110, a display selection component 112, and/or a sharing component 114.

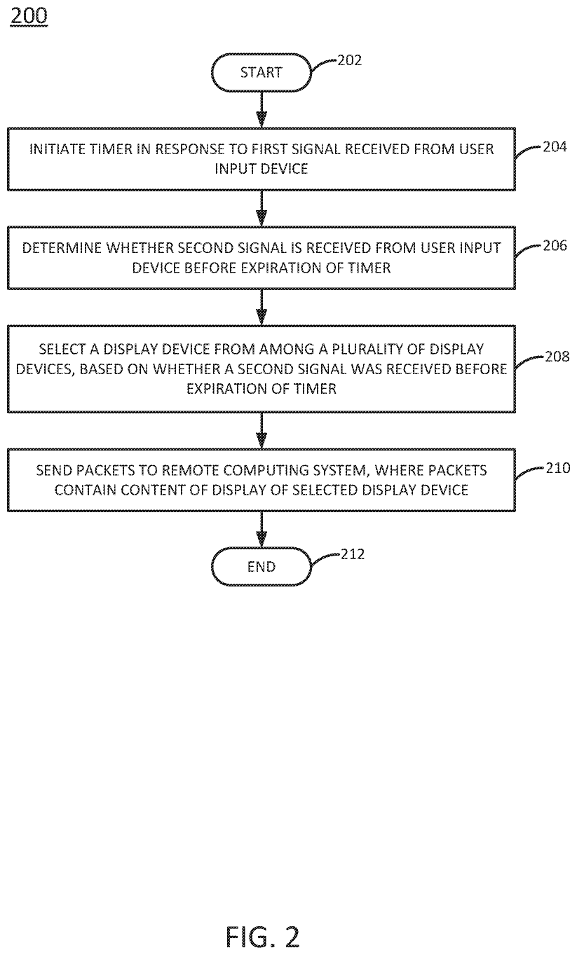

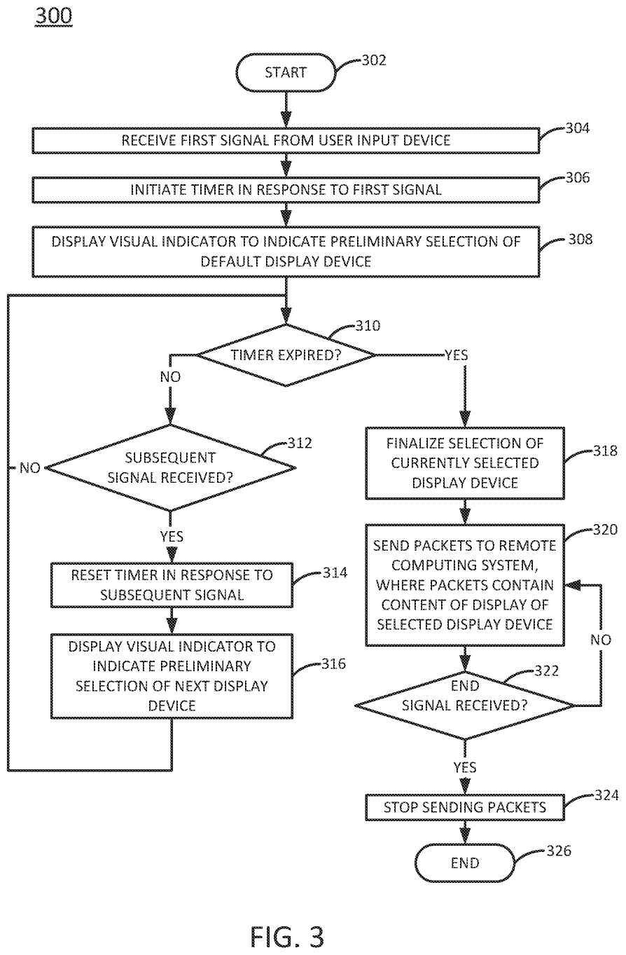

The timer component 110 may be configured initiate and monitor a timer that counts down a predefined period of time, for example as discussed in connection with FIGS. 2-3. The display selection component 112 may be configured to select a display device for screen sharing, for example as discussed in connection with FIGS. 2-3. The sharing component 114 may be configured for encoding display content into a set of data packets, for example as discussed in connection with FIGS. 2-3.

Furthermore, when a hardware processor executes instructions to perform “operations”, this could include the hardware processor performing the operations directly and/or facilitating, directing, or cooperating with another hardware device or component, e.g., a co-processor and the like, to perform the operations.

The processor executing the machine readable instructions relating to the below described method(s) can be perceived as a programmed processor or a specialized processor. As such, the present module 105 for screen sharing, including associated data structures, of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer.

As discussed above, the I/O devices 106 of the host computing system 100 include at least a user input device 106₁ and a queue 106ₓ of display devices 106ₓ₁-106ₓₙ. The user input device 106₁ may be any user input device that is capable of receiving a manual user input, such as a hardware wired or wireless keyboard, a touchscreen keyboard (e.g., a display including a mechanical or capacitive button or a touch-sensitive screen), a mouse, or another use input device. In one example, the user input device 106₁ includes a dedicated key or button (or other manually operable component that is capable of initiating signals to a processor) 108 that facilitates selection of a display device 106ₓ₁-106ₓₙ for screen sharing by sending a signal to the processor 102 to initiate one or more of the operations as discussed below in connection with the methods 200 and 300.

The queue 106ₓ of display devices 106ₓ₁-106ₓₙ may include any number of display devices. The display devices 106ₓ₁-106ₓₙ may all be of the same type, or may include display devices of various types. For instance, the queue 106ₓ of display devices 106ₓ₁-106ₓₙ may include one or more of: a computer monitor, a television set, a smart phone, a handheld gaming device, or another device.

FIG. 2 illustrates a flow diagram of a method 200 for selecting a display device from which to send display content to a remote computing system, The method 200 may be performed, for example, by the host computing system 100 of FIG. 1. As such, reference may be made in the discussion of the method 200 to components of the host computing system 100 of FIG. 1. However, such references are made for the sake of example, and are not intended to be limiting.

The method 200 begins in block 202. In block 204, the processor 102 initiates a timer in response to the receipt of a first signal from the user input device 106₁. In one example, the first signal is initiated in response to a user pressing the button 108 a first time. As discussed above, the button 108 may be a dedicated button that is used to initiate and control the process for selecting a display device 106ₓ₁-106ₓₙ from which to share display content (e.g., for selecting the screen to share). In one example, the timer counts down a predefined period of time (e.g., x seconds, where x could be zero or any number greater than zero).

In block 206, the processor 102 determined whether a second signal has been received from the user input device 106₁ before expiration of the timer, Whether or nota second signal is received before expiration of the timer will guide the processor in selecting a display device 106ₓ₁-106ₓₙ from among the queue 106ₓ for screen sharing.

In block 208, the processor 102 selects a display device 106ₓ₁-106ₓₙ from among the queue 106ₓ. As discussed above, the selection may be guided by whether or not a second signal was received from the user input device 106₁ before the timer expired. For instance, if a second signal is not received before the timer expires, then the processor 102 may select a default display device from among the display devices 106ₓ₁-106ₓₙ. However, if a second or subsequent signal is received before the timer expires, the processor 102 will begin to toggle through the display devices 106ₓ₁-106ₓₙ in the queue 106ₓ. In one example, each signal that is received before the timer expires resets the timer in addition to resetting the display device selection. For instance, a second signal received before the timer expires will reset the timer and change the selected display device from the default display device to a second display device in the queue. A third signal received before the timer expires will reset the timer and change the selected display device from the second display device to a third display device in the queue, and so on, until the timer expires. Once the timer expires before receipt of a subsequent signal, the display device that is currently selected is chosen for screen sharing.

In block 210, once the display device is selected, the processor 102 begins to send packets of data to a remote computing device. The packets contain content of the display of the selected display device. Thus, the host computing system 100 (e.g., via an active application) shares the content from the selected display device with the remote computing system, until the sharing is ended.

The method 200 ends in block 212.

FIG. 3 illustrates a flow diagram of another method 300 for selecting a display device from which to send display content to a remote computing system. In one example, the method 300 is a more detailed version of the method 200. Thus, the method 300 may be performed by the host computing system 100 of FIG. 1. As such, reference may be made in the discussion of the method 300 to components of the host computing system 100 of FIG. 1. However, such references are made for the sake of example, and are not intended to be limiting.

The method 300 begins in block 302. In block 304, the processor 102 receives a first signal from the user input device 106₁. In one example, the first signal is initiated in response to a user pressing the button 108 a first time. As discussed above, the button 108 may be a dedicated button that is used to initiate and control the process for selecting a display device 106ₓ₁-106ₓₙ from which to share display content (e.g., for selecting the screen to share).

In block 306, the processor 102 initiates a timer in response to the receipt of the first signal. In one example, the timer counts down a predefined period of time (e.g., x seconds).

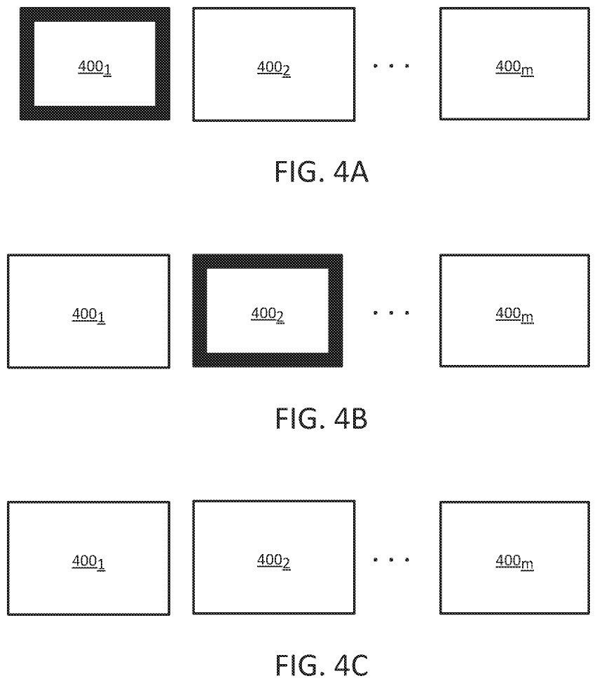

In block 308, the processor 102 displays a visual indicator to indicate a preliminary selection of a default display device. In one example, the default display device is a first display device in the queue 106ₓ. In one example, the visual indicator comprises a highlighted border displayed around the perimeter of the default display device's display. FIGS. 4A-4C, for instance, illustrate an example queue 400 of display devices 400₁-400ₘ during different stages of the method 300 illustrated in FIG. 3. As illustrated in FIG. 4A, the display device 400₁ is the default display device, and the highlighted border around the perimeter of its display indicates that the display device 400₁ has been preliminarily selected for screen sharing (e.g., in accordance with block 308 of the method 300). In further examples, different sorts of visual indicators may be implemented to indicate a currently selected display device, or the indicator may not even be visual at all (e.g., the indicator could be audible or tactile). In one example, blocks 306 and 308 may be performed substantially simultaneously.

In block 310, the processor 102 determines whether the timer initiated in block 306 has expired. If the processor 102 concludes in block 310 that the timer has expired, then the method 300 proceeds to block 318. In block 318, the processor 102 finalizes the selection of the currently selected display device (e.g., the default display device) for screen sharing.

If, however, the processor 102 concludes in block 310 that the timer initiated in block 306 has not expired, then the method 300 proceeds to block 312. In block 312, the processor 102 determines whether a subsequent signal has been received from the user input device 106₁. In one example, the subsequent signal is initiated in response to the user pressing the button 108 a subsequent time (i.e., subsequent to the first/most recent time the button 108 was pressed).

If the processor 102 concludes in block 312 that a subsequent signal has not been received, then the method 300 returns to block 310 and continues to monitor the status of the timer.

If, however, the processor concludes in block 312 that a subsequent signal has been received, then the method 300 proceeds to block 314. In block 314, the processor 102 resets the timer in response to the receipt of the subsequent signal. In one example, resetting the timer causes the timer to begin counting down the predefined period of time (e.g., x seconds) again.

In block 316, the processor 102 displays a visual indicator to indicate a preliminary selection of a next (non-default) display device in the queue (i.e., next relative to the default/most recently selected display device in the queue). In one example, the visual indicator comprises a highlighted border displayed around the perimeter of the next display device's display. As illustrated in FIG. 4B, the display device 400₂ is the next display device in the queue 400, and the highlighted border around the perimeter of its display indicates that the display device 400₂ has been preliminarily selected for screen sharing. In one example, blocks 314 and 316 may be performed substantially simultaneously.

The method 300 then returns to block 210 and continues to monitor the expiration of the timer as discussed above. In the event that the timer expires before a subsequent signal is received from the user input device 106₁, the method 300 proceeds to block 318 as discussed above, and the selection of the currently selected display device is finalized.

In block 320, the processor 102 begins sending packets to a remote computing system. In one example, the packets contain content of the display of the currently selected display device. Thus, the currently selected display device shares its screen with the remote computing system.

In block 322, the processor 102 determines whether an end signal has been received from the user input device 106₁. In one example, the end signal is initiated in response to the user pressing the button 108 at a time after the processor has begun sending packets to the remote computing system.

If the processor concludes in block 322 that an end signal has not been received, then the method 300 returns to block 320 and continues to send packets to the remote computing system.

If, however, the processor concludes in block 322 that an end signal has been received, then the method 300 proceeds to block 324. In block 324, the processor 102 stops sending packets to the remote computing system (i.e., stops sharing a screen with the remote computing system). As illustrated in FIG. 4C, none of the display devices 400₁-400ₘ has a highlighted border around its perimeter, indicating that screen sharing has been terminated.

The method 300 then ends in block 326.

Some examples of the disclosure may include an indicator to indicate to the user of the host computing system that screen sharing has been accepted by the remote computing system. For instance, when the remote computing system accepts screen sharing, the button 108 on the user input device 106₁ may light up (e.g., using an embedded light emitting diode or other illumination source) until either the remote computing system or the host computing system terminates the screen sharing.

Other examples of the present disclosure may allow a user to select a display device from which to share content using a button on a mouse or other input device, and to use a dedicated button on a wired or wireless keyboard to terminate sharing. Conversely, the dedicated button on the wired or wireless keyboard could be used to select a display device for sharing, and a button on a mouse or other input device could be used to terminate sharing.

It should be noted that although not explicitly specified, some of the blocks, functions, or operations of the methods 200 and 300 described above may include storing, displaying and/or outputting for a particular application. In other words, any data, records, fields, and/or intermediate results discussed in the methods can be stored, displayed, and/or outputted to another device depending on the particular application. Furthermore, blocks, functions, or operations in FIGS. 2-3 that recite a determining operation, or involve a decision, do not imply that both branches of the determining operation are practiced. In other words, one of the branches of the determining operation may not be performed, depending on the results of the determining operation.

It will be appreciated that variants of the above-disclosed and other features and functions, or alternatives thereof, may be combined into many other different systems or applications. Various presently unforeseen or unanticipated alternatives, modifications, or variations therein may be subsequently made which are also intended to be encompassed by the following claims.

What is claimed is:

1. A non-transitory machine-readable storage medium encoded with instructions executable by a processor, the machine-readable storage medium comprising:
instructions to initiate, in response to a first signal received from a user input device of a host computing system that includes a plurality of display devices, a timer to count down a defined period of time;
instructions to determine whether a second signal has been received from the user input device before an expiration of the timer;
instructions to select a first display device of the plurality of display devices, based on the determining; and
instructions to send a plurality of data packets to a remote computing system, wherein the plurality of data packets contains content of a display of the first display device.

2. The non-transitory machine-readable storage medium of claim 1, wherein the instructions to select comprise:
instructions to designate, in response to the first signal, a default display device of the plurality of display devices as the first display device.

3. The non-transitory machine-readable storage medium of claim herein the instructions to select further comprise:
instructions to finalize a selection of the default display device as the first display device when the timer expires before the second signal is received.

4. The non-transitory machine-readable storage medium of claim 2, wherein the instructions to select further comprise:
instructions to reset the timer in response to the second signal; and
instructions to designate, in response to the second signal, a non-default display device of the plurality of display devices as the first display device, when the second signal is received before the timer expires.

5. The non-transitory machine-readable storage medium of claim 4, further comprising:
instructions to finalize a selection of the non-default display device as the first display device when the timer, as reset, expires before a third signal is received from the user input device.

6. The non-transitory machine-readable storage medium of claim 2, wherein the instructions to designate comprise:
instructions to display a visual indicator to indicate a preliminary selection of the default display device as the first display device.

7. The non-transitory machine-readable storage medium of claim 6, wherein the visual indicator comprises a highlighted perimeter on a display of the default display device.

8. The non-transitory machine-readable storage medium of claim 1, wherein the user input device includes a dedicated component, and the first signal and the second signal are both initiated by respective inputs at the dedicated component.

9. The non-transitory machine-readable storage medium of claim 8, further comprising:
instructions to display a visual indicator on the dedicated key to indicate when the remote computing system accepts the plurality of packets.

10. The non-transitory machine-readable storage medium of claim 1, further comprising:
instructions to terminate the sending in response to a third signal received form the user input device, wherein the third signal is received after the sending has commenced.

11. The non-transitory machine-readable storage medium of claim 1, wherein the defined period of time is zero seconds.

12. A method, comprising:
initiating, in response to a first signal received from a user input device of a host computing system that includes a plurality of display devices, a timer to count down a defined period of time;
determining whether a second signal has been received from the user input device before an expiration of the timer;
selecting a first display device of the plurality of display devices, based on the determining; and
sending a plurality of data packets to a remote computing system, wherein the plurality of data packets contains content of a display of the first display device.

13. The method of claim 12, wherein selecting comprises;
designating, in response to the first signal, a default display device of the plurality of display devices as the first display device;
resetting the timer in response to the second signal;
designating, in response to the second signal, a non-default display device of the plurality of display devices as the first display device, when the second signal is received before the timer expires; and
finalizing a selection of the non-default display device as the first display device when the timer, as reset, expires before a third signal is received from the user input device.

14. An apparatus, comprising:
a plurality of manually operable components to initiate transmissions of signals to a processor,
wherein a first component of the plurality of manually operable components is dedicated to send signals that guide the processor in selecting a display device from which to send display content to a remote computing device, wherein the display device is one of a plurality of display devices communicatively coupled to the processor.

15. The apparatus of claim 14, wherein the apparatus is a keyboard, and the first component is a key of the keyboard.
